(19) United States
(12) Patent Application Publication
(10) Pub. No.: US 2010/0164865 A1
(43) Pub. Date: Jul. 1, 2010

(54) INFORMATION PROVIDING SYSTEM AND INFORMATION PROVIDING METHOD

(75) Inventors: Takashi HIRANO, Kawasaki (JP); Takayuki Yamaji, Kawasaki (JP); Kazutoshi Sakaguchi, Kawasaki (JP); Takefumi Horie, Kawasaki (JP); Kotaro Teranishi, Kawasaki (JP); Makoto Morioka, Kawasaki (JP)

Correspondence Address: Fujitsu Management Services of America, Inc., 2318 Mill Road, Suite 1010, Alexandria, VA, 22314, US

(73) Assignee: FUJITSU LIMITED, Kawasaki (JP)

(21) Appl. No.: 12/620,357

(22) Filed: Nov. 17, 2009

(30) Foreign Application Priority Data
Dec. 25, 2008 (JP) 2008-330116

(51) Int. Cl. G09G 5/00

(52) U.S. Cl. 345/156

(57) ABSTRACT

An information providing system includes a display unit installed in a table and having on the table, a display screen that displays an image of a product; a detecting unit that detects placement of an object at the position of the displayed image; and a display control unit that causes content related to the product to be displayed on the display screen when placement of the object at the position of the image is detected by the detecting unit.

### CROSS REFERENCE TO RELATED APPLICATIONS

This application is based upon and claims the benefit of priority of the prior Japanese Patent Application No. 2008-330116, filed on Dec. 25, 2008, the entire contents of which are incorporated herein by reference.

### FIELD

The embodiment discussed herein is related to a system and method of providing information related to a product.

### BACKGROUND

In recent years, at many eating establishments, such as family restaurants, toys are provided to customers with children. The provision of toys helps to keep children from leaving the table from the time of order until the meal is served (see, for example, Japanese Laid-Open Patent Publication No. 2007-4696).

However, since the toys can be played with away from the table, some children leave the table to play.

### SUMMARY

According to an aspect of an embodiment, an information providing system includes a display unit installed in a table and having on the table, a display screen that displays an image of a product; a detecting unit that detects placement of an object at the position of the displayed image; and a display control unit that causes content related to the product to be displayed on the display screen when placement of the object at the position of the image is detected by the detecting unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic depicting an overview of an information providing service that utilizes an information providing system according to an embodiment;

FIG. 2 is a schematic of screen transition;

FIG. 3 is a cross sectional view of a table;

FIG. 4 is a schematic depicting details of content;

FIG. 5 is a schematic of a configuration of the information providing system according to the embodiment;

FIG. 6 is a block diagram of a computer;

FIG. 7 is a block diagram of a display apparatus;

FIG. 8 is a schematic depicting partitioning of a display screen;

FIG. 9 is a schematic depicting one example of data configuration of a product master;

FIG. 10 is a schematic of one example of data configuration of a client master;

FIG. 11 is a schematic depicting one example of data configuration of table management information;

FIG. 12 is a sequence diagram of processing for providing information according to the embodiment;

FIG. 13 is a schematic of a specific example of toy detection at step S1201; and

FIG. 14 is a perspective view of another example of a table.

### DESCRIPTION OF EMBODIMENTS

An embodiment of the present invention will be explained with reference to the accompanying drawings. An information providing system of the embodiment is, for example, introduced at eating establishments, such as restaurants, bars, food courts, etc.

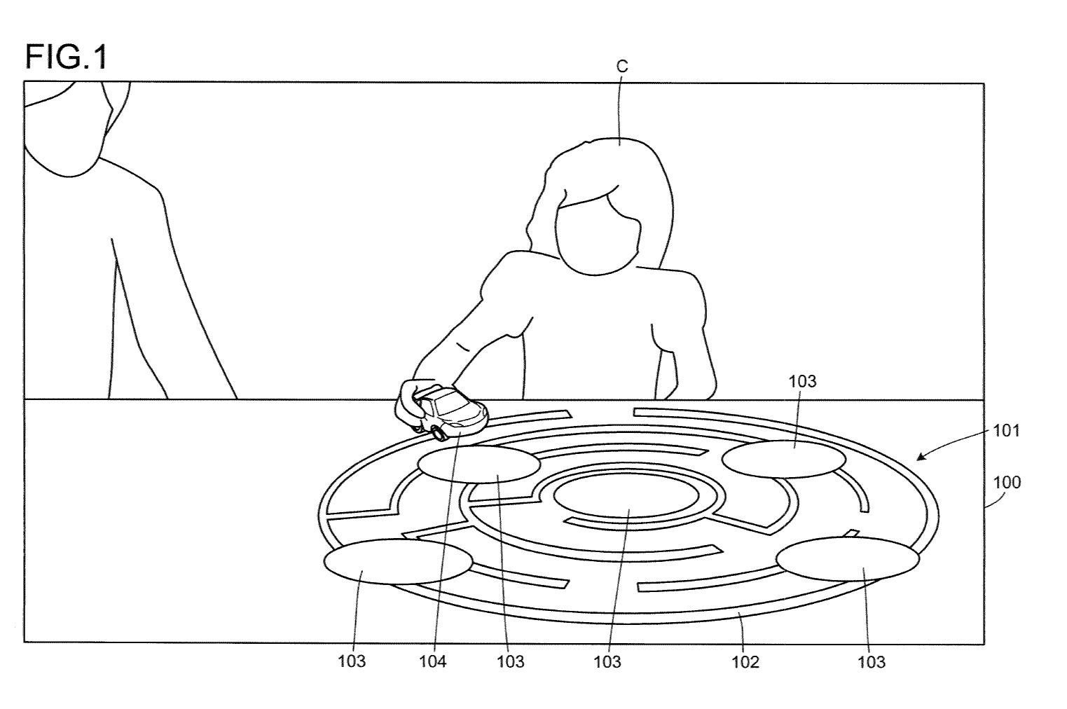

FIG. 1 is a schematic depicting an overview of an information providing service that utilizes an information providing system according to the embodiment. As depicted in FIG. 1, a customer with a child is seated at a table 100 in an eating establishment. A display screen 101 is on the surface of the table 100. In FIG. 1, an image of a maze 102 is displayed. Meals that have been ordered are displayed within circular figure 103 in the maze 102. A toy 104 (in FIG. 1, a toy car) is loaned to a child C and the toy 104 may be played with on the maze 102.

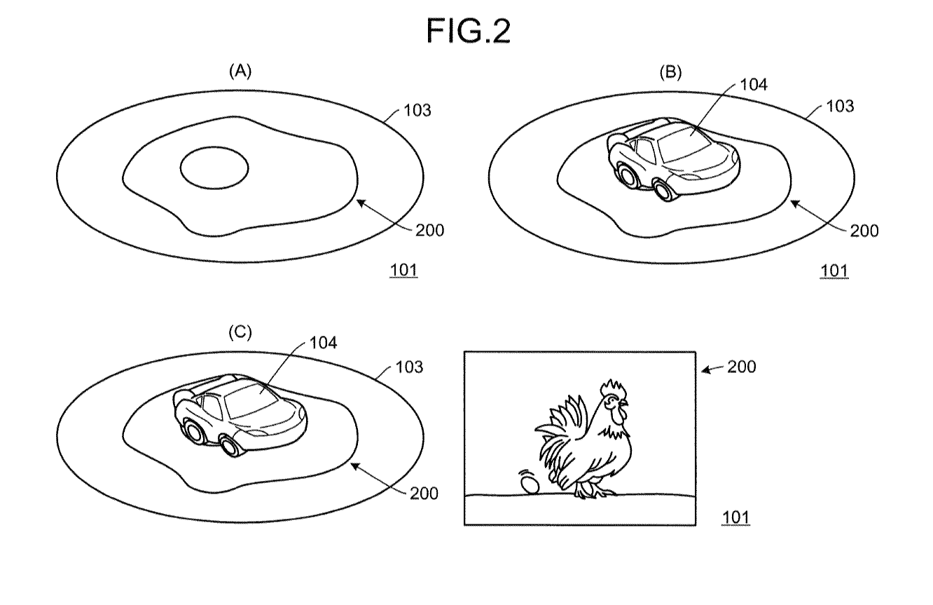

FIG. 2 is a schematic of screen transition. In section (A), a product image 200 of the ordered meal is displayed within a circular figure 103. In this example, an image of a fried egg is displayed. In section (B), a state in which the toy 104 is placed on a circular FIG. 103 is depicted. In section (C), content 201 related to the product image 200 of the meal is displayed in a vicinity of the circular figure 103. In this example, an image (may be a still image or a moving image) of a chicken egg from which the fried egg is prepared, is displayed.

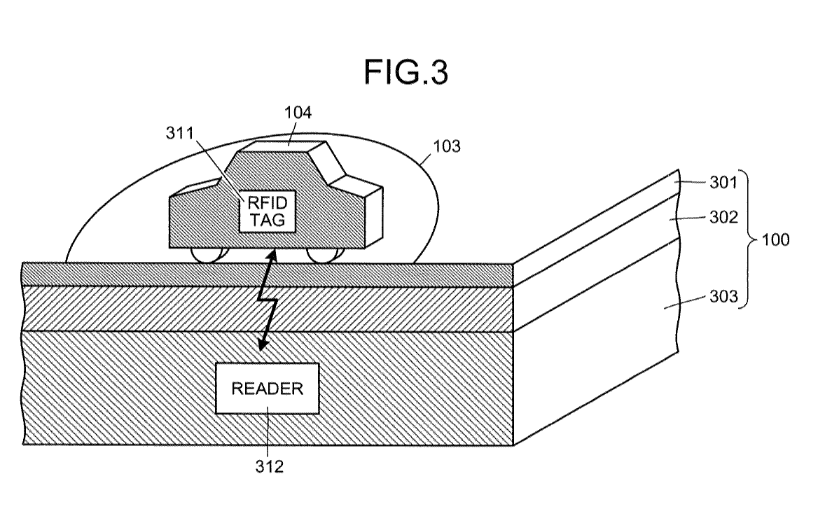

FIG. 3 is a cross sectional view of the table 100. FIG. 3 depicts the state depicted in section (B) of FIG. 2. The table, for example, is formed by three integrated layers including a transparent sheet 300 (e.g., a glass sheet), a display apparatus 302, and a table top 303. The toy 104 is equipped with an internal or external radio frequency identification (RFID) tag 311, and when the toy 104 is positioned directly on a circular figure 103, contactless communication is performed with a reader 312 embedded directly beneath the position of the circular figure 103 on the table 100.

Consequently, placement of the toy 104 on the circular figure 103 is detected. In the display apparatus 302, position information on the display screen 101 of the reader 312 is recorded and by the detection of the toy 104, the position information is sent to a host computer described hereinafter.

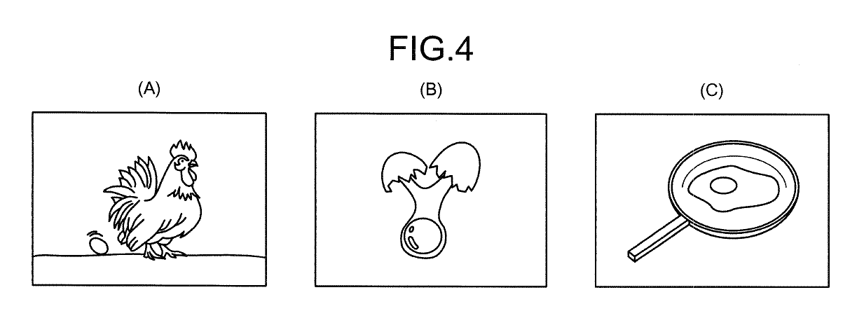

FIG. 4 is a schematic depicting details of the content 201. Section (A) depicts, as an initial image of the content 201 received from the host computer by contactless communication between the RFID tag 311 and the reader 312, a scene where a chicken is laying an egg. Section (B) depicts a scene where the egg is being cracked. Section (C) depicts a scene where the contents of the cracked egg are being fried in a pan to prepare a fried egg.

Placement of the toy 104 on the circular figure 103 having an image of the ordered meal (a fried egg) triggers the content 201, e.g. the series of the images displayed in sections (A) to (C) in FIG. 4, to be displayed and thereby enables the provision of information such as the ingredients used and preparation method. The content 201 may be only the ingredients, or only the preparation method. Further, the content 201 may be information concerning traceability or nutrition with respect to the ingredients.

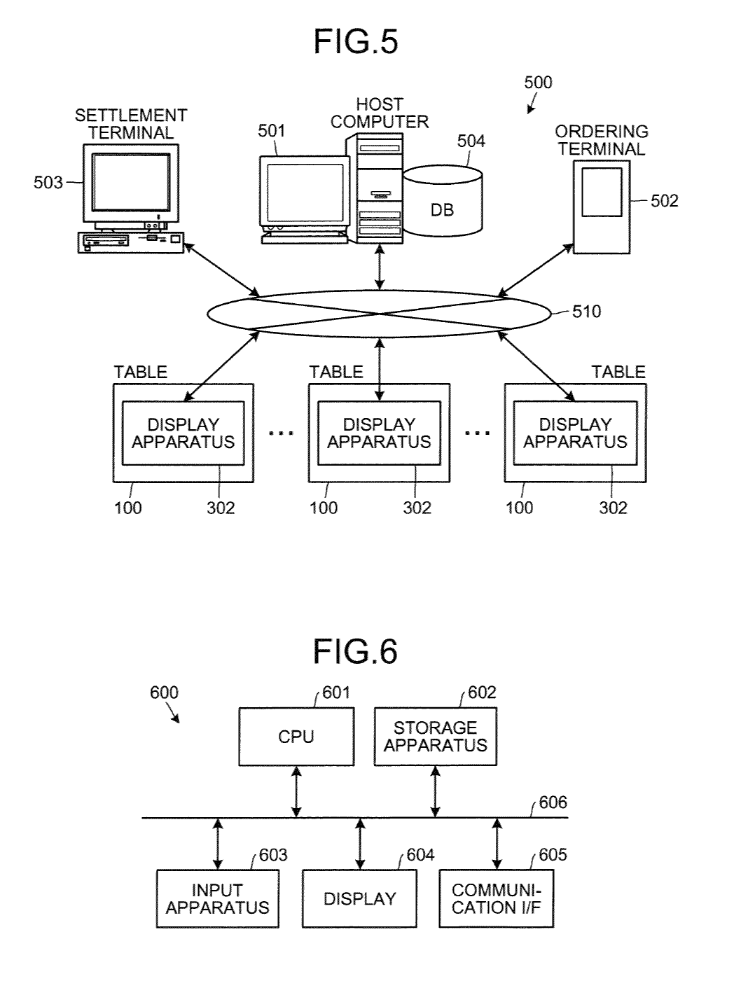

FIG. 5 is a schematic of a configuration of the information providing system according to the embodiment. A host computer 501, an ordering terminal 502, a settlement terminal 503, and display apparatuses 302 respectively provided at each table 100 included in information providing system 500 are communicably connected by a network 510 such as a local area network (LAN), a wireless LAN, etc.

The host computer 501 is a computer governing overall control of the information providing system 500. The host computer 501, specifically, executes processing for providing information according to the embodiment, conventional processing for order entry, etc. The host computer 501 includes a database (DB) 504. The DB 504 stores therein various types of data such as product masters, client masters, the product images 200, the content 201, etc.

The ordering terminal 502 is a computer that transmits data to the host computer 501 and is carried by a clerk. The clerk inputs, into the ordering terminal 502, the table number of the table 100 at which a customer is sitting and the product codes of items ordered. The settlement terminal 503 is a computer that settles the amount due when the customer leaves the eating establishment. Settlement information is transmitted to the host computer 501. Further, notification of settlement completion is transmitted from the settlement terminal 503 or through the host computer 501 to the display apparatus 302 of the table 100 at which the customer who has paid was seated.

FIG. 6 is a block diagram of a computer 600 (host computer 501, ordering terminal 502, and settlement terminal 503). As depicted in FIG. 6, the computer 600 includes a central processing unit (CPU) 601, a storage apparatus 602, input apparatus 603, a display 604, and a communication interface (I/F) 605, respectively connected through a bus 606.

The CPU 601 governs overall control of the computer 600. The storage apparatus 602 stores therein various types of information and specifically, for example, is formed by recording media such as read-only memory (ROM), random access memory (RAM), a magnetic disk drive and magnetic disk, etc. The input apparatus 603 includes input devices such as a keyboard, a mouse, a numeric key pad, buttons, etc. The display 604 displays various types of information. The communication I/F 605 is a module executing communication with other computers, the display apparatuses 302, etc.

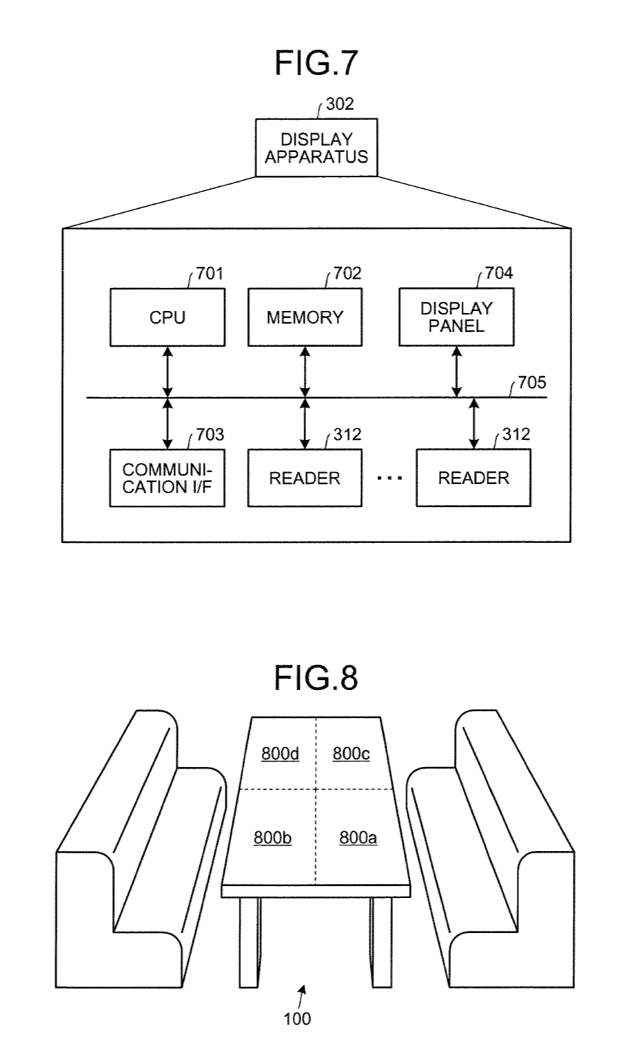

FIG. 7 is a block diagram of a display apparatus 302. A display apparatus 302 includes a CPU 701, a memory 702, a communication I/F 703, a display panel 704, and a reader 312, respectively connected through a bus 705. The CPU 701 governs overall control of the display apparatus 302 and specifically, for example, executes on/off control of screen areas, processing to identify the reader 312 that has communicated with an RFID tag 311, and control of the display screen 101.

The memory 702 stores therein various programs as well as table management information and map information. Map information is a background image representing paths such as the image of the maze 102 depicted in FIG. 1, exclusive of the circular figures 103. Under the display control, the product image 200 of the meal ordered by the customer is displayed within the circular figure 103. The map information may be preliminarily stored in the host computer 501 to be received from the host computer 501 and displayed.

The communication I/F 703 is a module executing communication with the host computer 501. The display panel 704 includes the display screen 101 and is provided to be viewable from a surface of the table 100. The reader 312, as depicted in FIG. 3, is embedded directly below the circular figure 103 displayed on the display screen 101 at a predetermined position, and by contactless communication with the RFID tag 311, reads outs information in the RFID tag 311. The quantity of readers 312, in this example, is equivalent to the quantity of circular figures 103.

Further, the display panel 704 displayed in FIG. 7 may be configured such that the display screen 101 is partitioned into areas for each customer seating position. FIG. 8 is a schematic depicting partitioning of the display screen 101. The table 100 depicted in FIG. 8 is a table for four customers and has screen areas 800a to 800d partitioned for the seating positions. Display may be independently turned on/off in each of the screen areas 800a to 800d.

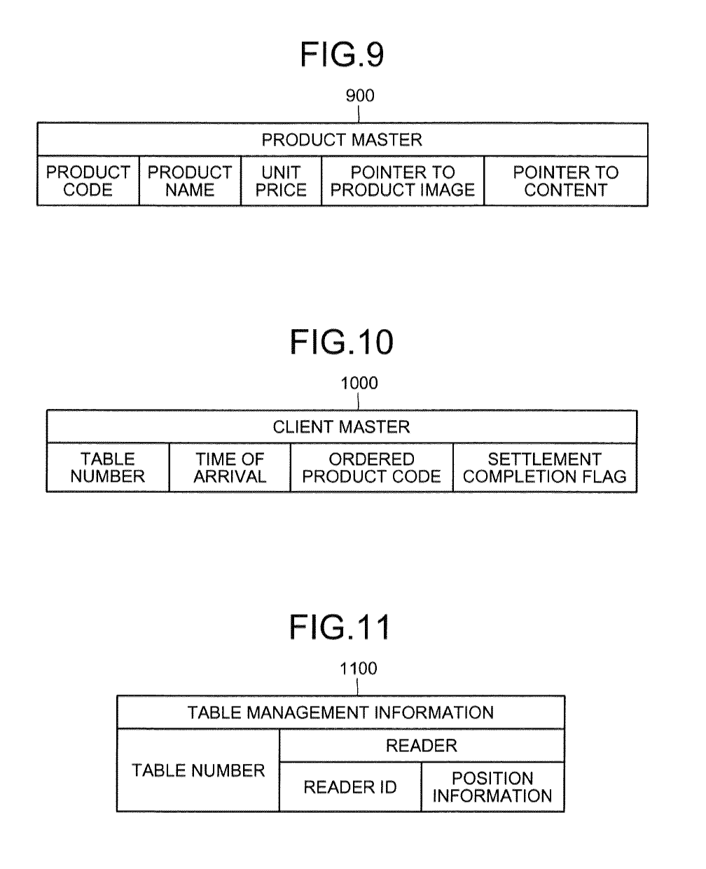

FIG. 9 is a schematic depicting one example of data configuration of a product master. A product master 900 is stored in the DB 504 of the host computer 501 and includes for each product, a product code, a product name, a unit price, a pointer to the product image 200, and a pointer to content 201. A product code is identification information uniquely identifying a product. A product name is character string data indicating the name of a product. Unit price is numeric data indicating the unit value of a product.

A pointer to a product image 200 is an address pointing to a product image 200. A pointer to content 201 is an address pointing to content 201 related to a product. The product master 900, excluding the pointers to the product images 200 and to the content 201, is further stored in the ordering terminal, the settlement terminal 503 etc.

FIG. 10 is a schematic of one example of data configuration of a client master 1000. The client master 100 is stored in the DB 504 of the host computer 501 and includes, for each table 100, a table number, time of arrival, an ordered product code, and a settlement completion flag. A table number is identification information uniquely identifying a table 100. Time of arrival is the time at which a customer is seated at a table 100, and in this example, is the time at which the host computer 501 receives order information (table number and ordered product code) from the ordering terminal 502.

An ordered product code is the product code of a product ordered by a customer. A settlement completion flag is a flag indicating whether a customer has settled the bill. In the present example, if the bill has not been settled, the value is “0”; and if settled, the value is “1”.

FIG. 11 is a schematic depicting one example of data configuration of table management information 1100. The table management information 110 is recorded in the memory 702 of each display apparatus 302 and includes the table number of the table 100, the reader ID of each reader 312 internally provided in the display apparatus 302, and position information concerning positions on the display screen 101.

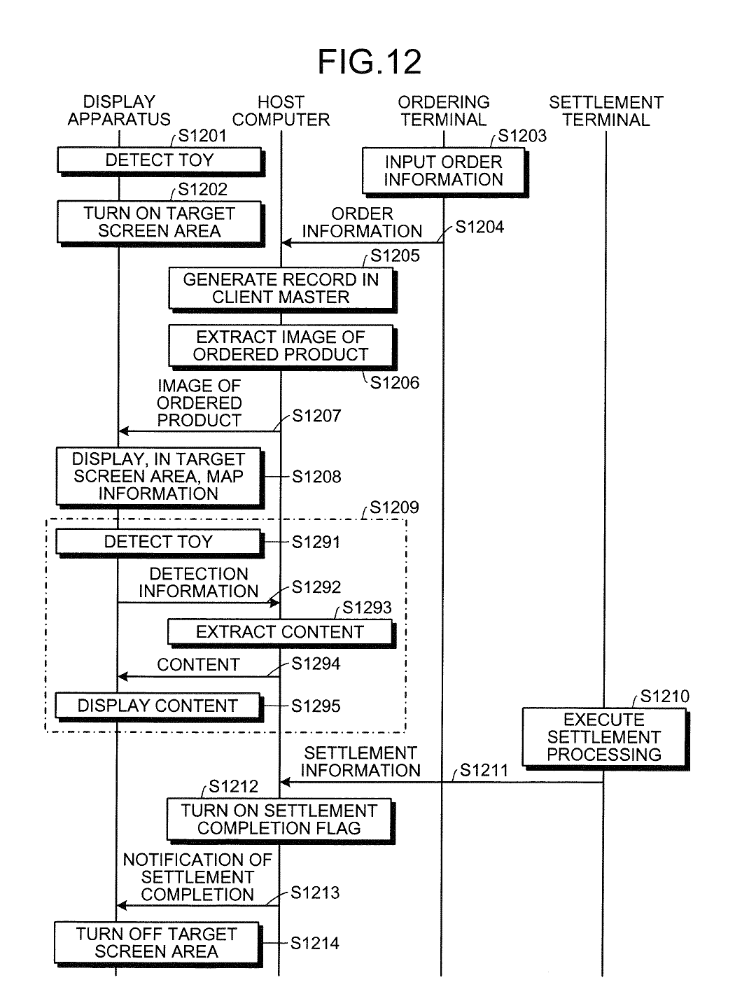

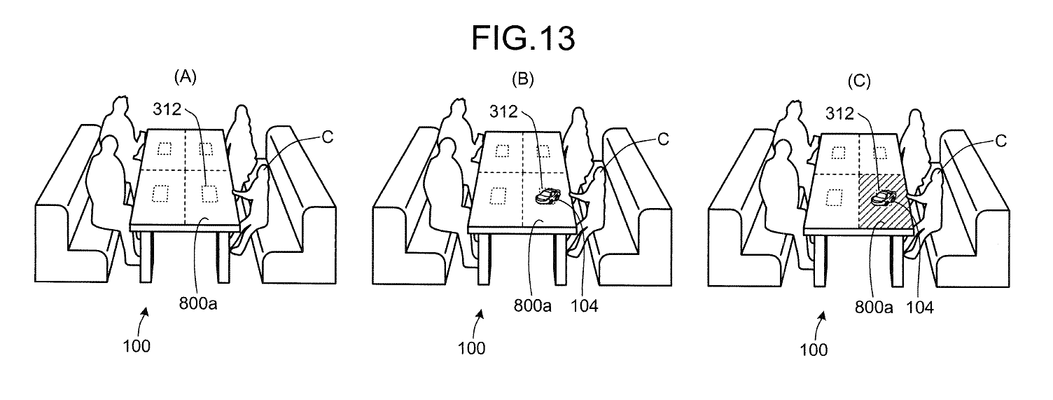

FIG. 12 is a sequence diagram of processing for providing information according to the embodiment. At a display apparatus 302, a toy 104 is detected (step S1201). FIG. 13 is a schematic of a specific example of toy detection at step S1201. Depicted in section (A) of the figure, a clerk confirms the seating positions of customers at a table 100, brings a toy 104 and places the toy 104 on the screen area where a child C is seated, making the screen area 800a of the child C, the target screen area (section (B)).

Since the clerk knows the position where the circular figure 103 is displayed at the target screen area 800a, the toy 104 may be placed at that position. At this time, as depicted in FIG. 3, contactless communication is performed between the RFID tag 311 in the toy 104 and the reader 312 in the table 100. Consequently, as depicted in section (C) of the figure, the CPU 701 of the display apparatus 302 identifies the target screen area 800a embedded with the reader 312, and turns on only the target screen area 800a (step S1202). Thus, at the screen area 800a where the child C is seated, information may be provided.

Further, the clerk operates the ordering terminal 502 that he carries and inputs the table number of the table 100 at which customers are seated (step S1203). By a pressing of a transmission button, the ordering terminal 502 transmits order information (the input table number and ordered product code(s)) to the host computer 501 (step S1204).

The host computer 501, upon receiving the order information, executes order entry processing identical to a conventional order entry system, and generates a record for the table 100 in the customer master 1000 (step S1205).

The host computer 501 then accesses the product master 900, uses, as a clue, the ordered product code written in the record to identify the pointer to the product image 200, and extracts from the DB 504, a product image 200 correlated with the ordered product code (step S1206). The host computer 501 transmits the extracted product image 200 and the ordered product code thereof to the display apparatus 302 identified by the table number included in the order information (step S1207). In the target screen area, map information is displayed (step S1208).

Subsequently, content display processing is executed (step S1209). Content display processing (step S1209) is repeatedly executed each time the toy 104 is detected. Specifically, for example, the placement of the toy 104 on the circular figure 103 that is the targeted screen area is detected (step S1291).

Specifically, as depicted in FIG. 3, the RFID tag 311 in the toy 104 and the reader 312 in the table 100 perform contactless communication. Through the contactless communication, the CPU 701 reads from the table management information stored in the memory 702, the reader ID of the reader 312 that has performed the contactless communication and together with the table number and the ordered product code transmits the reader ID as detection information to the host computer 501 (step S1292).

The host computer 501 accesses the product master 900, uses the ordered product code included in the received detection information as a clue to identify the pointer to the content 201 related to the product, and extracts from the DB 504, the content 201 correlated with the ordered product code (step S1293). The host computer 501 transmits the extracted content 201 together with the detection information to the display apparatus 302 identified by the table number included in the detection information (step S1294).

The display apparatus 302 uses the content 201 together with the reader ID in the received detection information as a clue to read out, from the table management information 1100, position information for the reader 312. The position indicated by the read-out position information is offset by a given amount and at the resulting position, the content 201 is displayed (step S1295). Thus, since content 201 related to the product for which the product image 200 is displayed at the position where the toy 104 has been placed may be displayed, during the time until the meal is served, the child C is not bored and an enjoyable learning experience with respect to dietary education is possible.

Subsequently, when the customer leaves after finishing the meal, the settlement terminal 503 executes settlement processing (step S1210). In the settlement processing, the table number of the table 100 at which the customer was seated is input to the settlement terminal 503 and, the product master 900 and the customer master 1000 are referenced to calculate the charges to be settled by the customer.

When settlement information is transmitted to the host computer 501 (step S1211), the host computer 501 refers to the table number of the settlement information and raises the settlement completion flag (changes the value from “0” to “1”) in the corresponding record in the customer master 1000 (step S1212). Then, the host computer 501 transmits settlement completion notification to the display apparatus 302 corresponding to the table number (step S1213). The display apparatus 302, upon receiving the settlement completion notification, turns off the target screen area (step S1214). Consequently, the resetting of the target screen area is able to occur automatically at the time of settlement thereby reducing the workload of the clerk.

As described, according to the embodiment, during the time a customer waits for the meal to be served, a child C is able to play with a toy 104 and map information while learning about food. Thus, the child C does not leave the table and the waiting time may be put to effective use in conjunction with promoting the dietary education of the child C. Further, in the embodiment, an example has been given where the toy 104 is car; however, configuration is not limited hereto, and the toy 104 may be a stuffed animal, a doll, a comic book, picture book, etc. Further, the child C may be allowed to choose from among various items.

In the embodiment, the display apparatus 302 is integrated with the table 100; however, the display apparatus 302 may be independent of the table 100. In this case, by placing the display apparatus 302 on the table 100 in front of the position where the child C is seated, information may be provided without a partitioning into screen areas. Further, existing tables may be used as is and hence, renovation work is unnecessary thereby making introduction simple and easy.

In the embodiment, through the contactless communication between the RFID tag 311 in the toy 104 and the reader 312 in the table 100, placement of the toy 104 on the table 100 is detected; however, configuration is not limited hereto and the position of the toy 104 may be recognized by a camera (not depicted) equipped above the table 100 to detect that the toy 104 has been placed on the table 100.

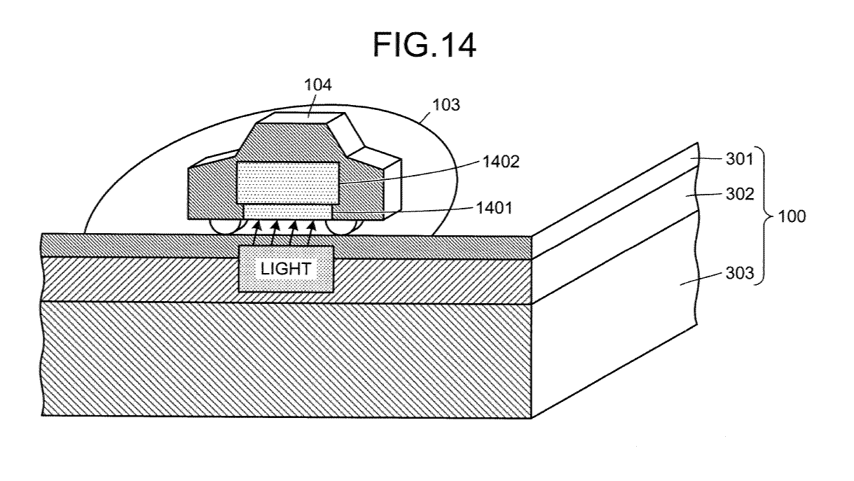

Further, in place of the RFID tag 311, the toy 104 may be equipped with an optoelectro conversion element (e.g., a photodiode) and a wireless communication device. FIG. 14 is a perspective view of another example of a table. In this case, the circular figure 103 is of a uniform color equal to or greater than the active area of the photodiode (emitted light having the optical receiving sensitivity frequency of the photodiode). Consequently, placement of the toy 104 on the circular figure 103 causes light from the circular figure 103 to be received by the photodiode 1401.

The wireless communication device 1402 detects that the photodiode 1401 has received light and transmits through the network 510 to the host computer 501, detection information indicating that the toy 104 has been placed on the circular figure 103 (step S1292).

Thus, through the use of the photodiode 1401 and the wireless communication device 1402, installation of the reader 312 in the table 100 is unnecessary. Therefore, since an existing table may be used as is, renovation work is unnecessary thereby enabling easy and simple introduction.

The information providing method explained in the present embodiment may be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information providing system comprising:
a display unit installed in a table and having on the table, a display screen that displays an image of a product;
a detecting unit that detects placement of an object at the position of the displayed image; and
a display control unit that causes content related to the product to be displayed on the display screen when placement of the object at the position of the image is detected by the detecting unit.

2. The information providing system according to claim 1 further comprising:
a receiving unit that receives, from an ordering terminal, a table number that identifies the table at which a customer is seated and a code for the product ordered by the customer;
an extracting unit that extracts from a database, the image of and the content related to the product identified by the received code, wherein
the display control unit causes the image of the product identified by the received code to be displayed on the display screen of a display apparatus of the table identified by the received table number and at which the customer is seated, and causes the content to be displayed on the display screen of the display apparatus when placement of the object is detected on the image of the product.

3. The information providing system according to claim 2, wherein
the detecting unit detects an initial placement of the object on a screen area selected from among screen areas of the display screen partitioned for each seating position, and
the display control unit causes the content to be displayed in the selected screen area when the object is detected on the image of the product.

4. The information providing system according to claim 1, wherein the detecting unit detects placement of the object through position recognition using an image captured by a camera positioned above the table.

5. The information providing system according to claim 3, wherein the display control unit causes an image related to pathways to the image of the product to be displayed, among selected screen areas, in an area other than where the image of the product is displayed.

6. The information providing system according to claim 1, wherein the content is information concerning materials used to make the product.

7. The information providing system according to claim 1, wherein the content includes information concerning a method of preparing the product.

8. The information providing system according to claim 1, wherein the content includes traceability information for the product.

9. The information providing system according to claim 2, wherein
the receiving unit receives, from a settlement terminal, notification of settlement completion concerning the table number, and
the display control unit controls the display screen to not display when notification of settlement completion has been received by the receiving unit.

10. The information providing system according to claim 1, wherein the display control unit is integrated with the table.

11. The information providing system according to claim 1, wherein the display control unit is separable from the table.

12. An information providing method comprising:
displaying on a display screen that is on a table, an image of a product;
detecting placement of an object at the position of the displayed image; and
displaying content related to the product on the display screen when placement of the object at the position of the image is detected at the detecting.
